(19) United States
(12) Patent Application Publication
(10) Pub. No.: US 2007/0073508 A1
(43) Pub. Date: Mar. 29, 2007

(54) Testing apparatus for optical access network

(75) Inventors: Seishiro Taniguchi, Fukuoka (JP); Atsushi Tanaka, Fukuoka (JP); Wataru Nakashima, Fukuoka (JP); Wataru Nakamura, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/341,591

(22) Filed: Jan. 30, 2006

(30) Foreign Application Priority Data
Sep. 29, 2005 (JP) 2005-284459

(51) Int. Cl. G01M 19/00; G06F 19/00

(52) U.S. Cl. 702/122

(57) ABSTRACT

In a testing apparatus for an optical access network, a converting unit converts an optical signal received through the optical access network into an electrical signal to create 10b coded data. A protocol processing unit performs a processing according to a protocol of the optical access network on the 10b coded data, and records a plurality of different protocol processing data corresponding to protocol information assigned to a plurality of ONUs. A memory unit stores the 10b coded data output from the converting unit. A CPU analyzes the 10b coded data in the memory unit.

### CROSS-REFERENCE TO RELATED APPLICATIONS

This application is based upon and claims the benefit of priority from the prior Japanese Patent Application No. 2005-284459, filed on Sep. 29, 2005, the entire contents of which are incorporated herein by reference.

### BACKGROUND OF THE INVENTION

1. Field of the Invention

The present invention relates to a testing apparatus for testing a relay device in an optical access network according to a gigabit Ethernet (GbE).

2. Description of the Related Art

The IEEE802.3ah is an optical access network standard. A testing apparatus for a relay device conforming to the IEE802.3ah standard has not yet been available in the market. Due to this, a test for such relay device has conventionally been carried out as follows.

FIG. 7 is a block diagram of a conventional testing system. An optical line terminal (OLT) 1 shown in FIG. 7 is a relay device to be tested. The OLT 1 is a gigabit-Ethernet passive-optical network (GE-PON) device on a station side. An Ethernet tester (or a server) 2 is connected to the OLT 1 via an Ether network 3 (for example, Japanese Patent Laid-Open Publication No. 2005-20420).

Optical network units (ONU) 4 are GE-PON devices, on a subscriber side, connected to the OLT 1 via a GbE optical-access network 5. Ethernet testers (or a personal computers (PC)) 6 are connected to the ONU 4 via an Ether network 7. The Ethernet testers 6 are testers for testing Ethernet.

As shown in FIG. 7, to test a single unit of the OLT 1, a plurality of ONUs 4 are connected to one unit of the OLT 1 via the GbE optical-access network 5 in a similar manner as an actual operation in the market. To confirm data communication between a backbone network and a subscriber, an Ethernet tester, a personal computer (PC), or a work station (WS) is connected to each of the ONUs 4.

FIG. 8 is a block diagram of the ONU 4. As shown in FIG. 8, the ONU 4 includes an optical-electrical/electrical-optical (OE/EO) unit 11, an encoding unit 12, an IEEE802.3ah-protocol processing unit 13, and an Ethernet INF unit 14.

The OE/EO unit 11 is connected to the GbE optical-access network 5 via an interactive optical fiber cable 8. The OE/EO unit 11 receives optical signals transmitted from the OLT 1 via the GbE optical-access network 5 and the optical fiber cable 8, and converts received optical signals into electrical signals. The OE/EO unit 11 also converts electrical signals into optical signals to transmit to the OLT 1 via the GbE optical-access network 5. The encoding unit 12 encodes 10b coded serial data output from the OE/EO unit 11 into 8b coded parallel data. The encoding unit 12 also decodes 8b coded parallel data output from the IEEE802.3ah-protocol processing unit 13 into 10b coded serial data.

The IEEE802.3ah-protocol processing unit 13 carries out an IEEE802.3ah protocol processing on 8b coded data that are output by the encoding unit 12. The Ethernet interface (INF) 14 connects the ONU 4 to the Ethernet tester (or PC) 6 that serves the ONU 4.

The IEEE802.3ah-protocol processing unit 13 includes a preamble identifying unit 15, a medium-access-control (MAC)-layer identifying unit 16, a fixed-preamble generating unit 17, a fixed-MAC generating unit 18, a fixed-data generating unit 19, a data inserting unit 20, a MAC inserting unit 21, and a preamble inserting unit 22. The preamble identifying unit 15 identifies a preamble area of IEEE802.3ah 8b coded frame data that are transmitted from the encoding unit 12.

The MAC-layer identifying unit 16 identifies a MAC layer of the IEEE802.3ah frame data that is transmitted from the preamble identifying unit 15. The fixed-preamble generating unit 17 generates preamble data in 8b code that are fixedly allocated to a single unit of the ONU 4 during the IEEE802.3ah protocol processing. The fixed-MAC generating unit 18 generates a MAC header in 8b code that are fixedly set during the IEEE802.3ah protocol processing.

The fixed-data generating unit 19 generates 8b coded frame data that are fixedly set during the IEEE802.3ah protocol processing. The data inserting unit 20 inserts the frame data to a transmission frame. The MAC inserting unit 21 inserts the MAC header to the transmission frame. The preamble inserting unit 22 inserts the preamble data to the transmission frame. Thus, the transmission frame is assembled.

In the ONU 4, the OE/EO unit 11 receives the optical signals that are input from the GbE optical-access network 5 and converts the received optical signals into electrical signals of 10b coded frame data. The encoding unit 12 converts the received frame data in 10b code into 8b coded data. The 8b coded data is subjected to the IEEE802.3ah protocol processing in the IEEE802.3ah-protocol processing unit 13. During transmission, the encoding unit 12 converts the 8b coded data into 10b coded transmission frame data. The OE/EO unit 11 converts the transmission frame data into optical signals, and outputs the optical signals to the GbE optical-access network 5.

However, when a test is performed simultaneously at each of the ONU 4 and each of the Ethernet tester 6 in the conventional testing system, plural units of the ONUs 4 and plural units of the Ethernet testers 6 are required for a single unit of the OLT 1. Therefore, cost and a scale of the testing system increase.

When the scale increases, for example, a factory is required to prepare a large space to install the testing system to perform a test before shipment. If a plural units of the OLT 1 is to be tested, the number of the ONUs 4 and the Ethernet testers 6 required for the test significantly increases.

### SUMMARY OF THE INVENTION

It is an object of the present invention to at least solve the above problems in the conventional technology.

A testing apparatus according to one aspect of the present invention is for testing a device that is connected to the testing apparatus via an optical access network. The testing apparatus includes a converting unit configured to convert an optical signal received through the optical access network into an electrical signal to create 10b coded data; a protocol processing unit configured to perform a processing according to a protocol of the optical access network on the 10b coded data; and an encoding unit configured to encode the 10b coded data to 8b coded data.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a testing apparatus for an optical access network according to an embodiment of the present invention;

FIG. 2 is a schematic of a protocol processing table and a search key;

FIG. 3 is a schematic for illustrating a frame format of the IEEE802.3ah standard;

FIG. 4 is a schematic for illustrating a frame format of a DIX specification;

FIG. 5 is a block diagram of a testing system that uses the testing apparatus for the optical access network according to the embodiment;

FIG. 6 is a flowchart of a frame processing in a test executed by the testing apparatus according to the embodiment;

FIG. 7 is a block diagram of a conventional testing system; and

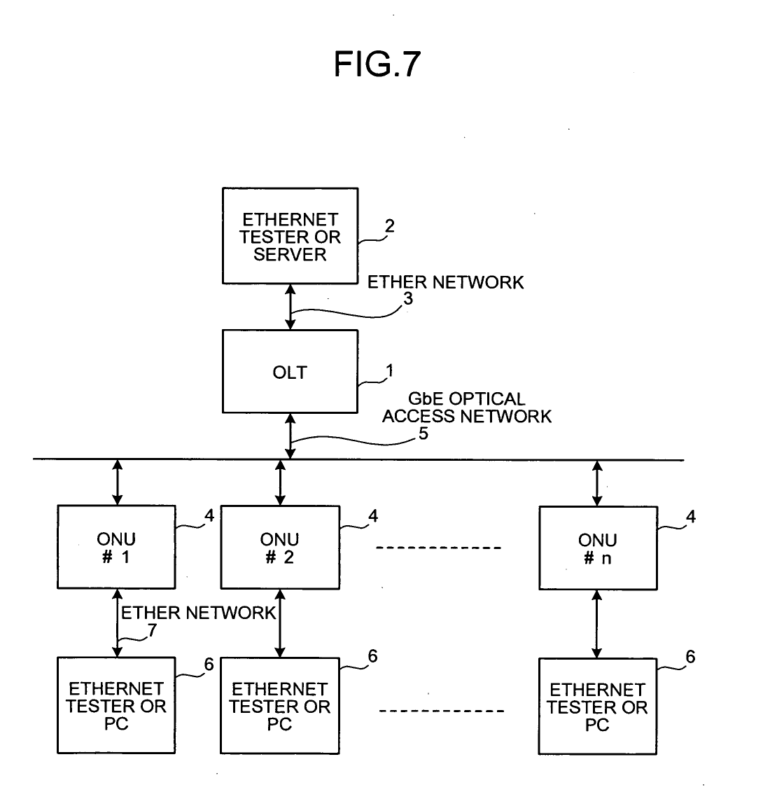

FIG. 8 is a block diagram of an ONU shown in FIG. 7.

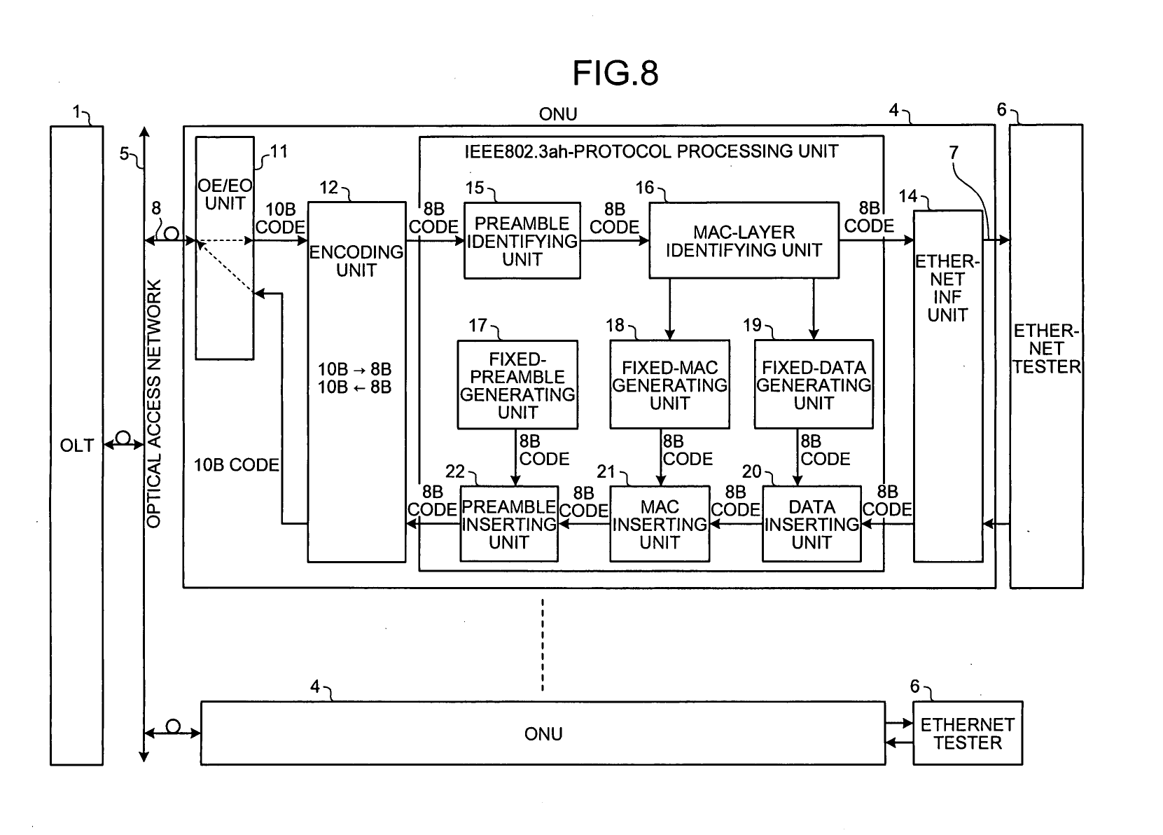

### DETAILED DESCRIPTION OF THE PREFERRED EMBODIMENTS

Exemplary embodiments according to the present invention are explained in detail below with reference to the accompanying drawings.

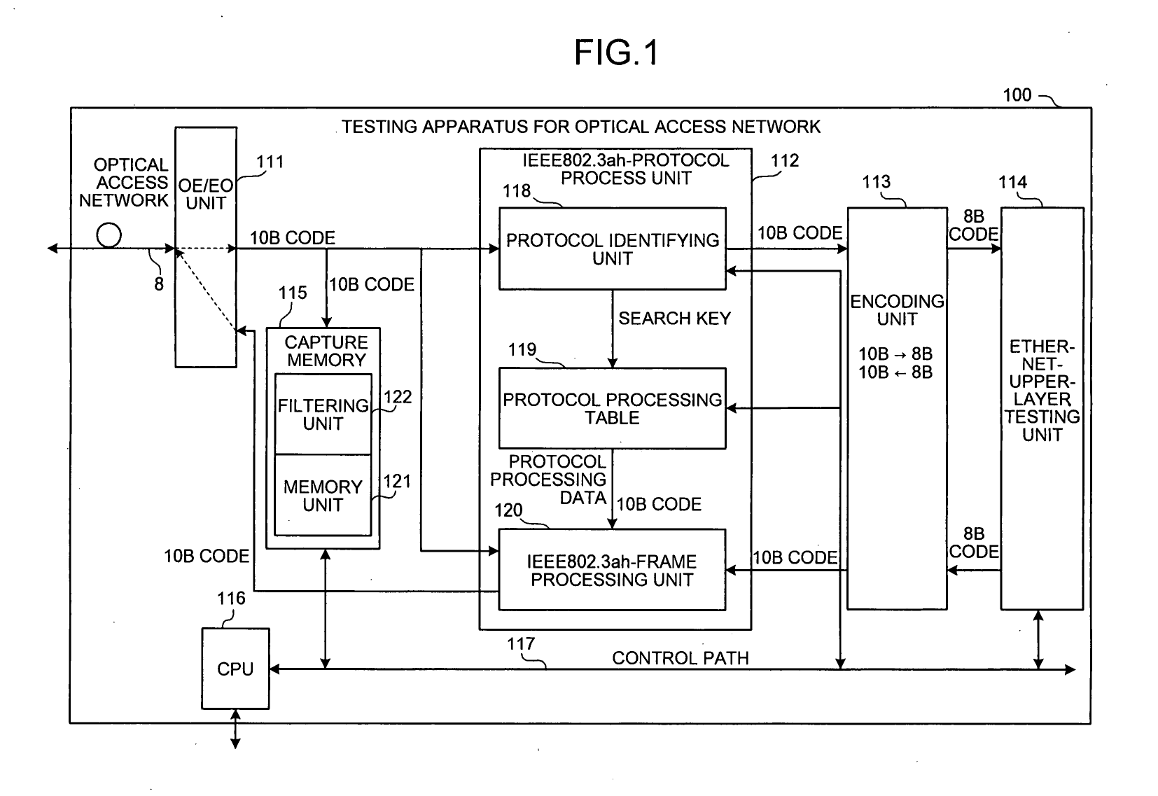

FIG. 1 is a block diagram of a testing apparatus for an optical access network according to an embodiment of the present invention. As shown in FIG. 1, a testing apparatus 100 includes an OE/EO unit 111, an IEEE802.3ah-protocol processing unit 112, an encoding unit 113, an Ethernet-upper-layer testing unit 114, a capture memory 115, and a central processing unit (CPU) 116 that are connected to each other via control paths 117.

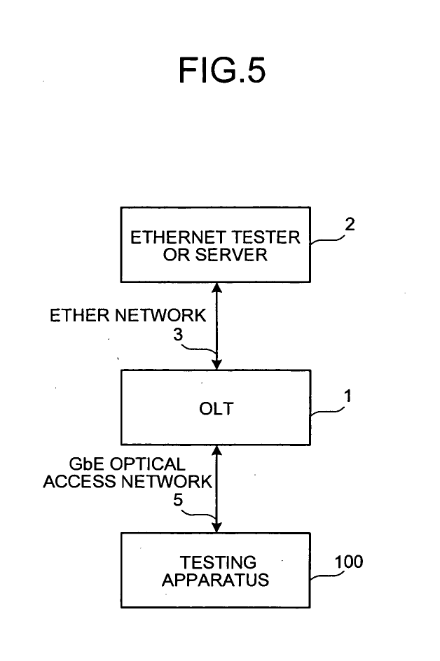

The OE/EO unit 111 is connected to the GbE optical access network 5 (see FIG. 5) via an interactive optical fiber cable 8. The OE/EO unit 111 receives optical signals that are transmitted via the GbE optical-access network 5 and the optical fiber cable 8, and converts the received optical signals into electrical signals to generate received frame data formed with 10b coded serial data. The received frame data is transmitted to the IEEE802.3ah-protocol processing unit 112 in the form of 10b code. The OE/EO unit 111 converts into optical signals, transmission frame data formed with 10b coded serial data that are transmitted from the IEEE802.3ah-protocol processing unit 112, and outputs the converted optical signals to the GbE optical-access network 5 via the optical fiber cable 8.

The IEEE802.3ah-protocol processing unit 112 includes a protocol identifying unit 118, a protocol processing table 119, and an IEEE802.3ah-frame processing unit 120. The IEEE802.3ah-protocol processing unit 112 carries out an IEEE802.3ah protocol processing on the received frame data in the form of 10b code. The protocol identifying unit 118 analyzes the received frame data that are transmitted from the OE/EO unit 111, and identifies whether the received frame data is a frame data of an IEEE802.3ah protocol or an IEEE802.3 frame.

If the received frame data is of the IEEE802.3ah standard, the protocol identifying unit 118 generates an identification code for a protocol processing, and combines the identification code with a testing code to generate a search key. The search key is used to select protocol data from the protocol processing table 119. The CPU 116 sets the testing code. If the received frame data is not a frame data of the IEEE802.3ah standard, the protocol identifying unit 118 does not generate the search key.

Furthermore, if the received frame data is a frame data of the IEEE802.3ah standard, the protocol identifying unit 118 does not transfer the received frame data to the encoding unit 113. If the received frame data is any other type of frame data, the protocol identifying unit 118 transfers the received frame data in the form of 10b code to the encoding unit 113. The CPU 116 controls whether to transfer the received frame data to the encoding unit 113.

The protocol processing table 119 includes multiple entries of protocol data and frame data corresponding to the IEEE802.3ah protocol and the IEEE802.3 frame respectively. Based on the search key, an appropriate entry is selected from among the entries in the protocol processing table 119. The protocol processing table 119 is rewritable by the CPU 116.

The IEEE802.3ah-frame processing unit 120 obtains protocol data of the entry selected based on the search key. By using a preamble, a MAC header, and response data, the IEEE802.3ah-frame processing unit 120 assembles response frame data conforming to the proper IEEE802.3ah standard, and outputs the response frame data via the OE/EO unit 111 to the GbE optical-access network 5 at predetermined timing. The response frame data is transmitted either within a transmission timing that is stipulated by received electrical signals and the IEEE802.3ah standard, or at a timing indicated in timing data set in the protocol processing table 119.

The encoding unit 113 encodes 10b coded serial data that passes through the protocol identifying unit 118 into 8b coded parallel data, and transmits the 8b coded parallel data to the Ethernet-upper-layer testing unit 114. The encoding unit 113 decodes the 8b coded parallel data that are transmitted from the Ethernet-upper-layer testing unit 114 into 10b coded serial data, and transmits the 10b coded serial data to the IEEE802.3ah-frame processing unit 120. The IEEE802.3ah-frame processing unit 120 transmits the parallel data in the form of 10b code that are transmitted from the Ethernet-upper-layer testing unit 114 to the OE/EO unit 111.

The Ethernet-upper-layer testing unit 114 is controlled by the CPU 116 and carries out testing of an Ethernet upper-layer packet. The Ethernet-upper-layer testing unit 114 is provided with an upper-layer frame generating function that enables the Ethernet-upper-layer testing unit 114 to generate the Ethernet upper-layer packet, and to transmit the Ethernet upper-layer packet to the GbE optical-access network 5 via the encoding unit 113, the IEEE802.3ah-frame processing unit 120, and the OE/EO unit 111.

The capture memory 115 includes a memory unit 121 that stores in the form of 10b code the received frame data that is received from the GbE optical-access network 5, a filtering unit 122 that sorts data for storing in the memory unit 121 according to specified filtering conditions, and a control function that controls the memory unit 121 and the filtering unit 122. The CPU 116 specifies the filtering conditions. Logic to avoid filtering can also be set in the filtering unit 122.

The CPU 116 controls the entire testing apparatus 100. The CPU 116 can communicate with a not shown external computer. The CPU 116 can read and analyze data that is captured in the memory unit 121. The data captured in the memory unit 121 can also be read by the CPU 116, transmitted to the not shown external computer or display device, and analyzed by the personal computer or displayed in the display device.

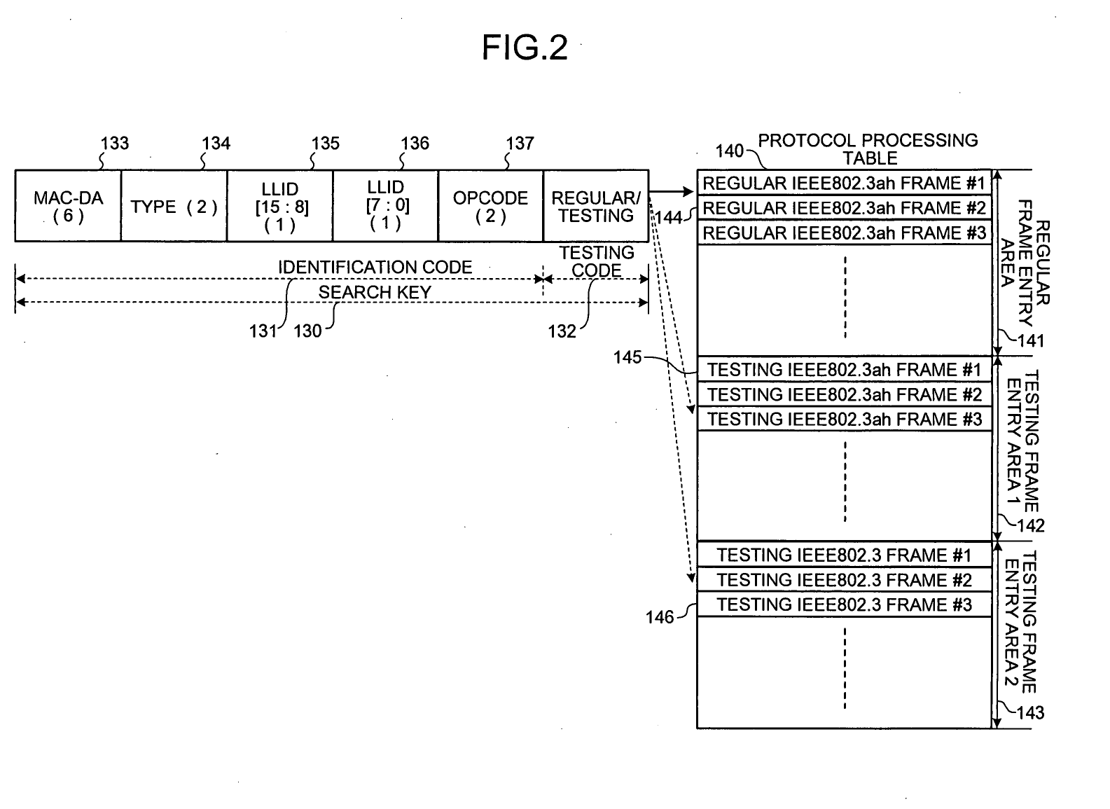

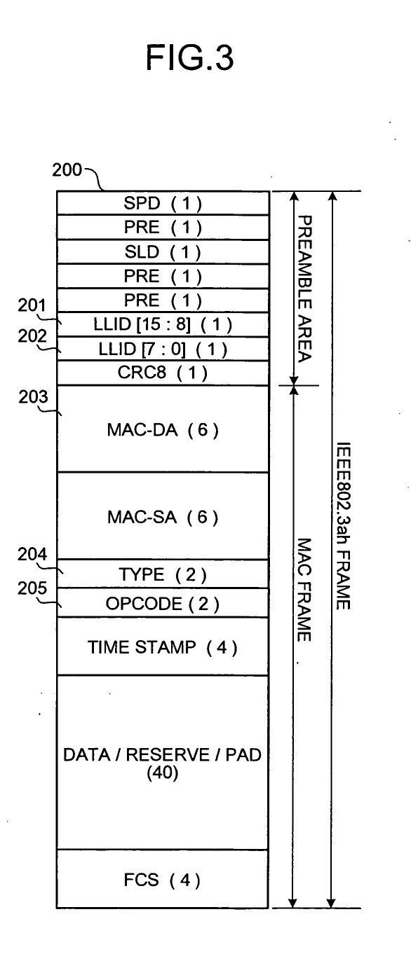

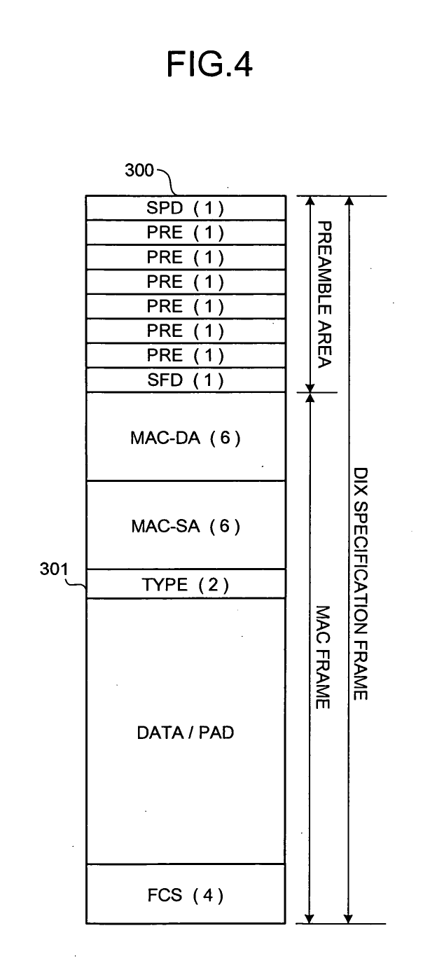

FIG. 2 is a schematic of the protocol processing table. FIG. 3 is a schematic for illustrating a frame format of the IEEE802.3ah standard and FIG. 4 is a schematic for illustrating a frame format of a DIX specification. As shown in FIG. 2, a search key 130 includes an identification code 131 that is generated from the IEEE802.3ah frame, and a testing code 132 that is set by the CPU 116.

For example, the identification code 131 includes a MAC-DA 133, a Type 134, an LLID [15:8] 135, an LLID [7:0] 136, and an Opcode 137. The MAC-DA 133, the Type 134, the LLID [15:8] 135, the LLID [7:0] 136, and the Opcode 137 of the identification code 131 correspond respectively to a MAC-DA 203, a Type 204, an LLID [15:8] 201, an LLID [7:0] 202, and an Opcode 205 that are assigned to an IEEE802.3ah frame format 200 shown in FIG. 3.

The LLID [15:8] 201 and the LLID [7:0] 202 indicate upper 8 bits and lower 8 bits respectively of a 2 byte LLID. LLID is an abbreviation of local link identification (ID), and Opcode is an abbreviation of operation code.

The testing code 132 is provided to determine whether the searched data is regular protocol data or testing protocol data. For example, a protocol processing table 140 is provided with a regular frame entry area 141, a testing frame entry area 1 (142), and a testing frame entry area 2 (143). The CPU 116 sets entry data of the regular frame entry area 141, the testing frame entry area 1 (142), and the testing frame entry area 2 (143).

Multiple entries 144 of regular protocol data corresponding to the IEEE802.3ah protocol are stored in the regular frame entry area 141. Multiple entries 145 of testing protocol data corresponding to the IEEE802.3ah protocol are stored in the testing frame entry area 1 (142). Storing standard violating data or 10b coded data defects as testing protocol data enables to increase testing variation.

Multiple entries 146 of protocol data corresponding to a DIX specification format are stored in the testing frame entry area 2 (143). This enables the IEEE802.3ah-frame processing unit 120 to generate a testing frame corresponding to the DIX specification format, thus enabling to correspond to data frames other than data frames that conforming to the IEEE802.3ah standard. The IEEE802.3ah standard and the DIX specification are identified from a value of the Type 134. The Type 134 of the identification code 131 corresponds to a Type 301 that is assigned to a DIX specification format 300 shown in FIG. 4.

As shown in FIG. 3 and FIG. 4, SPD, PRE, CRC, and SFD are abbreviations corresponding to start of packets, preamble, cyclic redundancy check, and start of packet delimiter respectively. The numerals inside brackets shown in FIG. 2 through FIG. 4 represent the number of bytes.

FIG. 5 is a block diagram of a testing system that uses the testing apparatus 100. As shown in FIG. 5, the testing apparatus 100 is connected via the GbE optical-access network 5 to an OLT 1 that is tested. An Ethernet tester (or a server) 2 is connected the OLT 1 via an Ether network 3.

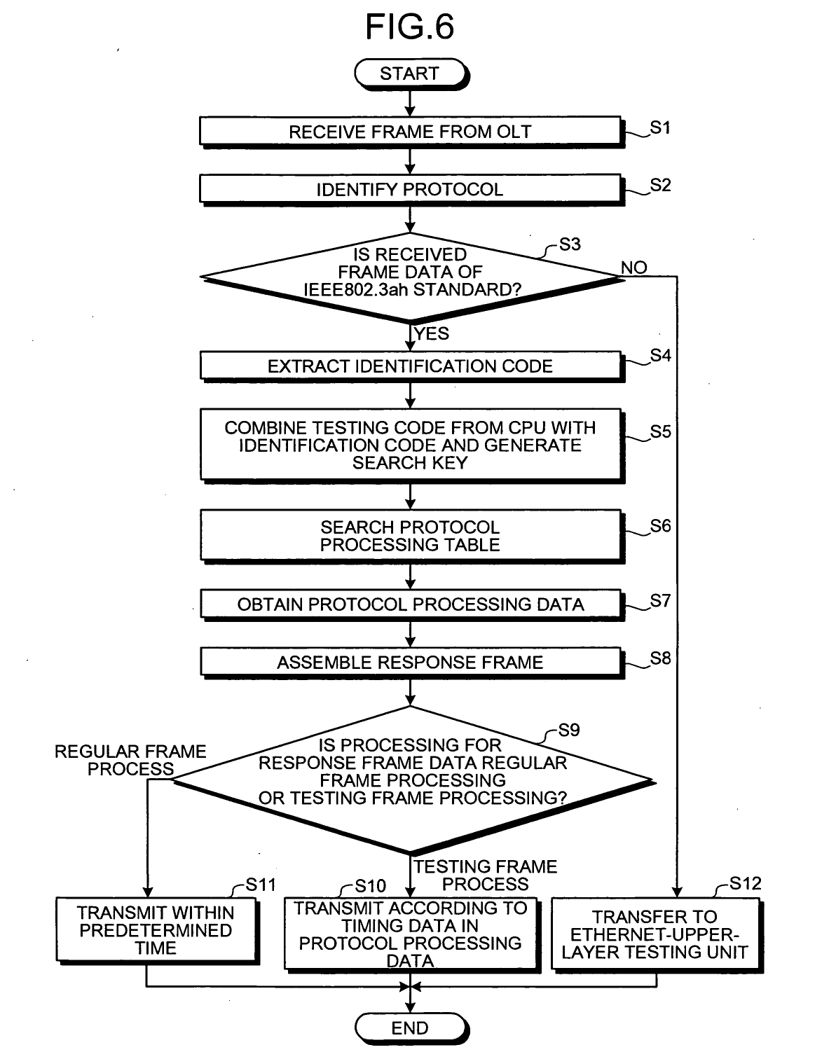

FIG. 6 is a flowchart of a frame process by the IEEE802.3ah-protocol processing unit 112 that executes a test with the testing system shown in FIG. 5. As shown in FIG. 6, the OE/EO unit 111 receives frame data of optical signals that are transmitted from the OLT 1 via the GbE optical-access network 5. The OE/EO unit 111 converts the received optical signals into electrical signals to generate received frame data in 10b code, and transmits the received frame data in the form of 10b code to the protocol identifying unit 118.

The protocol identifying unit 118 obtains the received frame data from the OLT 1 via the OE/EO unit 111 (step S1), and identifies protocol of the received frame data according to the IEEE802.3ah standard (step S2). Next, the protocol identifying unit 118 determines whether the received frame data is a frame data of the IEEE802.3ah standard (step S3).

If the received frame data is a frame data of the IEEE802.3ah standard (“YES” at step S3), the protocol identifying unit 118 extracts an identification code for the protocol processing (step S4). Next, the protocol identifying unit 118 combines the identification code with the testing code that is set by the CPU 116 to generate the search key (step S5). The protocol identifying unit 118 transmits the generated search key to the protocol processing table 119, and controls not to transfer the received frame data to the encoding unit 113.

The protocol processing table 119 obtains the search key from the protocol identifying unit 118, and searches the protocol processing table 140 for an entry that is specified by the search key (step S6). Next, the protocol processing table 119 selects protocol processing data (protocol data) from the entry based on the search key (step S7), and transmits the selected protocol processing data to the IEEE802.3ah-frame processing unit 120.

The IEEE802.3ah-frame processing unit 120 obtains the protocol processing data from the protocol processing table 119, and uses the protocol processing data to assemble response frame data of the regular IEEE802.3ah standard (step S8.). Next, the IEEE802.3ah-frame processing unit 120 determines whether a processing to be performed on the response frame data is a regular frame processing or a testing frame processing (step S9).

If the processing to be performed is the testing frame processing (“TESTING FRAME PROCESS” at step S9), based on the received electrical signals and timing data in the protocol processing data, the IEEE802.3ah-frame processing unit 120 computes transmission timing, and transmits the response frame data to the GbE optical-access network 5 via the OE/EO unit 111 (step S10). Thus, a series of process by the IEEE802.3ah-protocol processing unit 112 is finished.

If the processing to be performed is the regular frame process (“REGULAR FRAME PROCESS” at step 9), based on the received electrical signals and transmission timing specified by the IEEE802.3ah standard, the IEEE802.3ah-frame processing unit 120 transmits the response frame data at the specified timing to the GbE optical-access network 5 via the OE/EO unit 111 (step S11). Thus, a series of process by the IEEE802.3ah-protocol processing unit 112 is finished.

If the received frame data is not a frame data of the IEEE802.3ah standard at step S3 (“NO” at step S3), the protocol identifying unit 118 transfers the received frame data to the Ethernet-upper-layer testing unit 114 via the encoding unit 113 (step S12). Thus, a series of process by the IEEE802.3ah-protocol processing unit 112 is finished.

Upon receiving the response frame data, which is not a frame data of the IEEE802.3ah standard from the protocol identifying unit 118, the Ethernet-upper-layer testing unit 114 transmits the response frame data to the CPU 116. The CPU 116 analyzes the response frame data, and displays the analysis result in the not shown external display device.

The response data received from the protocol identifying unit 118 can also be analyzed in the not shown hard circuit and the analysis result can be displayed in the not shown external display device. The response frame data received from the protocol identifying unit 118 can also be displayed in the not shown external display device.

In the testing apparatus 100 according to the embodiment, multiple IEEE802.3ah protocol data are stored in the protocol processing table 140, thereby maintaining the protocol data that are fixedly allocated to multiple ONUs, and enabling to construct an environment equivalent to the environment in which multiple ONUs are connected to the OLT 1 via the GbE optical-access network 5. Thus, the GbE optical-access network 5 can be tested with a simple structure. Thus, it is possible to reduce the cost and space for testing.

Standard-violating protocol processing data or 10b coded data defects is set in the protocol processing table 140, and transmission frame data that is based on the standard-violating protocol data or the 10b coded data defects is transmitted to the GbE optical-access network 5, thereby providing a variety of verification patterns for the OLT 1. Thus, it is possible to judge whether the GbE optical-access network 5 conforming to the IEEE802.3ah standard is normal or defective.

Furthermore, the Ethernet-upper-layer testing unit 114 is provided in the testing apparatus 100. Therefore, it is possible to carry out verification of Ethernet. Thus, it is possible to judge whether the GbE optical-access network 5 conforming to the Ethernet interface standard is normal or defective.

The IEEE802.3ah-protocol processing unit 112 handles 10b coded data, stores in the capture memory 115 the received frame data in the form of 10b code, and analyzes the stored received frame data. Therefore, it is possible to identify an error that occurs in the GbE optical-access network 5, and to analyze optical circuit noise in 10b code.

The received frame data that is stored in the capture memory 115 is analyzed by using the CPU 116, the external display device, or the hard circuit, thereby enabling to detect defective codes in 10b code due to an optical circuit noise. Furthermore, the CPU 116 reads the received frame data that is stored in the capture memory 115 and displays the read received frame data in the external display device, thereby enabling to confirm the frame data that flows through the optical circuits.

The CPU 116 executes software to rewrite the protocol processing table 140. Therefore, it is possible to generate illegal data in the physical layer, thereby increasing types of verification data. Thus, generation of testing frames and variation in testing can be increased.

The filtering unit 122 in the capture memory 115 enables to capture only specific received frame data in the memory unit 121 and to analyze the captured received frame data. Therefore, it is possible to detect a defect early and to efficiently use the memory space in the memory unit 121.

The present invention is not limited to the above embodiments, and various modifications can be applied. For example, the testing apparatus 100 need not be provided with the inbuilt Ethernet-upper-layer testing unit 114. Instead of providing the Ethernet-upper-layer testing unit 114, an interface can be provided that-connects the testing apparatus 100 to an external Ethernet tester (or a personal computer). The Ethernet tester (or the personal computer) can be connected to the interface when carrying out a test.

According to the embodiments described above, it is possible to test an optical access network with a simple structure. Moreover, it is possible to judge whether a GbE optical-access network conforming to the IEEE802.3ah standard is normal or defective. Furthermore, it is possible to judge whether the GbE optical-access network conforming to the Ethernet interface standard is normal or defective.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A testing apparatus for testing a device that is connected to the testing apparatus via an optical access network, comprising:
a converting unit configured to convert an optical signal received through the optical access network into an electrical signal to create 10b coded data;
a protocol processing unit configured to perform a processing according to a protocol of the optical access network on the 10b coded data; and
an encoding unit configured to encode the 10b coded data to 8b coded data.

2. The testing apparatus according to claim 1, further comprising:
a memory unit configured to store, in a form of 10b code, the data output from the converting unit; and
a calculating unit configured to analyze the data stored in the memory unit.

3. The testing apparatus according to claim 2, further comprising a filtering unit configured to filter the data stored in the memory unit to sort the data.

4. The testing apparatus according to claim 1, wherein the protocol processing unit includes
a protocol processing table configured to record a plurality of different protocol processing data; and
a protocol identifying unit configured to identify the protocol, and to generate a search key corresponding to identified protocol.

5. The testing apparatus according to claim 4, wherein the protocol processing table is rewritable.

6. The testing apparatus according to claim 4, wherein
the protocol processing data includes response timing data, and
the protocol processing unit is configured to select protocol processing data that corresponds to the search key from among the protocol processing data in the protocol processing table, and to obtain response timing data from selected protocol processing data.

7. The testing apparatus according to claim 6, wherein the protocol processing unit further includes a frame processing unit configured to generate a response frame data based on the selected protocol processing data and obtained response timing data, and to output the response frame data to the optical access network via the converting unit.

8. The testing apparatus according to claim 4, wherein the protocol processing table is configured to further record testing data for generating 10b coded data.
